(19) United States
(12) Patent Application Publication
(10) Pub. No.: US 2025/0124903 A1
(43) Pub. Date: Apr. 17, 2025

(54) INFORMATION PROCESSING APPARATUS CONFIGURED TO PERFORM CONTROL BASED ON PERFORMANCE ACTIONS

(71) Applicant: CASIO COMPUTER CO., LTD., Tokyo (JP)

(72) Inventor: Masaru SETOGUCHI, Tokyo (JP)

(21) Appl. No.: 18/917,044

(22) Filed: Oct. 16, 2024

(30) Foreign Application Priority Data
Oct. 17, 2023 (JP) 2023-179123

(51) Int. Cl. G10H 1/00; G10H 1/34

(52) U.S. Cl. CPC G10H 1/0025; G10H 1/34; G10H 2210/161; G10H 2210/375

(57) ABSTRACT

An information processing apparatus includes: a storage storing a program; and a processor that performs control in accordance with the program, wherein a sound production timing is a timing of producing a sound of a note, the sound production timing being specified in a musical piece; and an early press period is between an early time point and the sound production timing, the early time point being earlier than the sound production timing by a predetermined time. In a situation that a performance action is detected within the early press period, the processor causes a sound production unit to produce a sound corresponding to the performance action at the sound production timing. In a situation that no performance action is detected within the early press period or at the sound production timing, the processor does not cause the sound production unit to produce a sound at the sound production timing.

### CROSS-REFERENCE TO RELATED APPLICATIONS

This application is based upon and claims the benefit of priority from the Japanese Patent Application No. 2023-179123, filed on Oct. 17, 2023, the entire contents, including the description, claims, abstract and drawings of which are incorporated herein by reference.

### TECHNICAL FIELD

The present disclosure relates to an information processing apparatus, an electronic musical instrument, a sound production control method, and a storage medium storing a program.

### DESCRIPTION OF RELATED ART

In playing a musical piece, a player is required to produce sounds at timings and at pitches specified in a musical score. Although a skilled player may intentionally deviate from sound production timings (perfect timings) specified in the musical score to express grooves, the basic is to play the musical piece in accordance with sound production timings specified in the musical score.

### SUMMARY OF THE INVENTION

According to the present disclosure, an information processing apparatus includes: a storage that stores a program; and a processor configured to perform control in accordance with the program stored in the storage, wherein a sound production timing is a timing of producing a sound of a target note, the sound production timing being specified in a musical piece; an early press period is between an early time point and the sound production timing, the early time point being earlier than the sound production timing by a predetermined time; in a situation that a performance action is detected within the early press period, the processor causes a sound production unit to produce a sound corresponding to the performance action at the sound production timing; and in a situation that no performance action is detected within the early press period or at the sound production timing, the processor does not cause the sound production unit to produce a sound at the sound production timing.

### BRIEF DESCRIPTION OF DRAWINGS

The accompanying drawings are not intended as a definition of the limits of the invention but illustrate embodiments of the invention, and together with the general description given above and the detailed description of the embodiments given below, serve to explain the principles of the invention, wherein:

FIG. 1 is a block diagram showing functional components of an information processing apparatus in an embodiment of the present disclosure;

FIG. 2 is a figure to explain a timing control process in a performance support function;

FIG. 3 is a flowchart of main processing to be executed by a CPU in FIG. 1;

FIG. 4 is a flowchart of a MIDI data process A with the performance support, which is executed in Step S104 of FIG. 3 when the performance support function is on in the first embodiment;

FIG. 5 is a flowchart of a tick process A to be executed by the CPU of FIG. 1 in the first embodiment;

FIG. 6 is a flowchart of a MIDI data process B with the performance support, which is executed in Step S104 of FIG. 3 when the performance support function is on in the second embodiment;

FIG. 7 is a flowchart of a tick process B to be executed by the CPU of FIG. 1 in the second embodiment; and

FIG. 8 is a schematic drawing for explaining the performance support operation in the second embodiment.

### DETAILED DESCRIPTION

It is very difficult for beginners to make performance actions at perfect timings. Performance actions by beginners may be earlier or later than perfect timings, thereby resulting in a performance that fails to get into the rhythm.

There is a technology for supporting performances of beginners. For example, JP 2007-72387A discloses an electronic musical instrument configured to produce a musical sound according to performance data when a predetermined time elapses after a timing at which a performance action should be made during a specific period in the performance data. According to JP 2007-72387A, the specific period, which the player cannot play well, is played automatically instead of manual playing by the player, so that the entire piece of music is smoothly played from the beginning to the end.

According to the performance support described in JP 2007-72387A, the electronic musical instrument merely provides automatic playing of the specific period that the player cannot play well, instead of manual playing by the player. The electronic musical instrument cannot appropriately correct sound production timings corresponding to the performance actions by the player, based on correct sound production timings specified in a musical piece.

It is desirable that timings for producing sounds corresponding to the performance actions be appropriately corrected, based on sound production timings specified in a musical piece.

Hereinafter, embodiments of the present disclosure are described with reference to the figures. However, the embodiments described below have various limitations which are technically preferable for carrying out the present invention. Therefore, the technical scope of the present invention is not limited to the following embodiments and illustrated examples.

### First Embodiment

### [Configuration of Information Processing Apparatus 1]

A configuration of an information processing apparatus 1 in a first embodiment of the present disclosure is described.

The information processing apparatus 1 is configured to support a user (player) playing an electronic musical instrument 2 connected to the information processing apparatus 1 via a musical instrument digital interface (MIDI) interface 107.

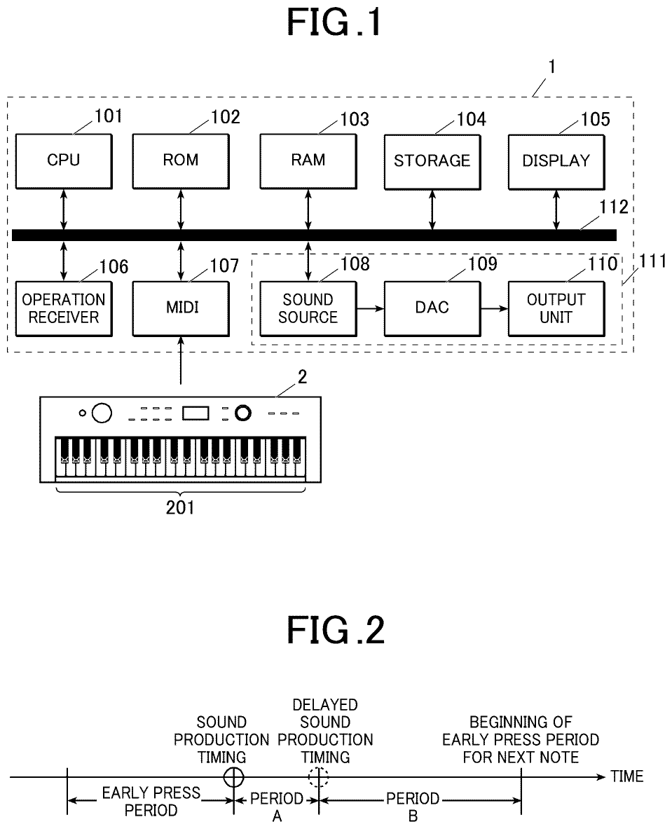

As shown in FIG. 1, the information processing apparatus 1 includes a central processing unit (CPU) 101, a read only memory (ROM) 102, a random access memory (RAM) 103, a storage 104, a display 105, an operation receiver 106, the MIDI interface 107, a sound source 108, a digital analog converter (DAC) 109, and an output unit 110. These components are connected via a bus 112.

The CPU 101 (processor) is a computer that controls the elements constituting the information processing apparatus 1. The CPU 101 serves as a controller. The CPU 101 reads a specified program among programs stored in the ROM 102 or the storage 104, loads the program in the RAM 103, and executes various processes in cooperation with the loaded program. The CPU 101 may be constituted of multiple CPUs, and processes may be executed by the multiple CPUs constituting the CPU 101.

The ROM 102 stores programs and various kinds of data.

The RAM 103 provides the CPU 101 with a working memory space and stores temporary data.

The storage 104 is constituted of a nonvolatile semiconductor memory, such as a flash memory, a hard disc drive (HDD), or the like. The storage 104 stores programs and various kinds of data. The storage 104 is not limited to a storage within the information processing apparatus 1. The storage 104 may include an external storage medium attachable to and detachable from the information processing apparatus 1, such as an external HDD or a USB memory.

In this embodiment, the storage 104 stores music data of multiple musical pieces (e.g., MIDI data). The music data includes information on sound production timings (the time from the beginning of the music), pitches, velocity values (strengths), and (tones) of notes lengths constituting musical pieces, for example.

The display 105 consists of a liquid crystal display (LCD) or an electro-luminescence (EL) display, for example. The display 15 displays various contents in accordance with display information provided by the CPU 101.

The operation receiver 106 includes multiple pushbutton switches. The operation receiver 106 detects operations made on the pushbutton switches and outputs operation signals to the CPU 101.

Although the operation receiver 106 in this embodiment is constituted of pushbutton switches, the operation receiver 106 may include a touchscreen attached to the display 105 and output, to the CPU 101, operation signals corresponding to the operations made on the touchscreen.

The MIDI interface 107 is connected to the electronic musical instrument 2 and sends and receives data to and from the electronic musical instrument 2 in accordance with the MIDI protocol.

The sound source 108 reads waveform data (audio data) stored in the ROM 102 beforehand or generates waveform data in accordance with instructions by the CPU 101 and outputs the waveform data to the DAC 109.

The DAC 109 performs D/A conversion on the waveform data output by the sound source 108 and outputs analog sounds.

The output unit 110 includes an amplifier and a speaker. The output unit 110 amplifies the analog sounds input by the DAC 109, such as sounds of a musical instrument, and outputs the amplified sounds.

The sound source 108, the DAC 109, and the output unit 110 constitute the sound production unit 111.

The electronic musical instrument 2 is a keyboard instrument that includes a keyboard 201 constituted of multiple keys (performance action receivers), for example.

Every time any of the keys of the keyboard 201 is pressed or released, the electronic musical instrument 2 outputs MIDI data (note data, such as a note-on event and a note-off event) to the information processing apparatus 1 via a not-illustrated MIDI interface. For example, when any of the keys is pressed on the keyboard 201, the electronic musical instrument 2 outputs a note-on event including information on a pitch and a velocity. When any of pressed keys is released, the electronic musical instrument 2 outputs a note-off event including information on a pitch and so forth. The electronic musical instrument 2 also outputs MIDI data (e.g., information such as control changes or program changes) corresponding to operations made on a not-illustrated operation receiver to the information processing apparatus 1 via the not-illustrated MIDI interface.

### [Operation of Information Processing Apparatus 1]

Next, the operation of the information processing apparatus 1 in this embodiment is described.

When the performance support function is turned on via the operation receiver 106, the information processing apparatus 1 corrects pitches and timings of performance actions made by the user such that the musical sounds (notes) constituting the selected musical piece are produced at correct timings and at correct pitches. In the present application, a performance action refers to an action for producing the sound of a note, namely an action of pressing a key(s) (note-on).

FIG. 2 is a figure to explain a timing control process in the performance support function. In FIG. 2, a musical piece proceeds with time from left to right along the time axis.

In FIG. 2, the solid-line circle indicates a sound production timing at which a sound of a note (musical sound) constituting a melody of a musical piece should be produced. The note the sound of which should be produced at the sound production timing is referred to as a target note. The dashed-line circle indicates a delayed sound production timing that is set at a point of time later than the sound production timing by a predetermine time. The sound of the target note is produced at the delayed sound production timing if an operation action corresponding to the target note is not detected from an early press period (described later) to the delayed sound production timing. The delayed sound production timing is a very short moment and is not a sound production timing specified by a musical piece. Therefore, the note-on timing by the user may slightly deviate from the delayed sound production timing.

As shown in FIG. 2, an early press period, a delayed sound production stand-by period (period A), and a period B are set in the performance support function. The early press period is between a point of time that is earlier than the sound production timing by a predetermined time and the sound production timing. The delayed sound production stand-by period (period A) is between the sound production timing and the delayed sound production timing. The period B is between the delayed sound production timing and the beginning of the early press period of the next note. The early press period, the period A, the delayed sound production timing, and the period B are set in a performance support target part (in this embodiment, a melody) of a musical piece.

When the performance support function is on, in response to detecting a performance action of the user (in response to receiving a note-on event from the electronic musical instrument 2) during the early press period, the CPU 101 does not immediately produce the sound of the target note corresponding to the performance action but suspends the sound production of the target note. When the sound production timing of the target note specified in the musical piece arrives, the CPU 101 causes the sound production unit 111 to produce the sound of the target note at a correct pitch specified in the musical piece. If a performance action is not detected until the sound production timing but is detected within the period A, the CPU 101 causes the sound production unit 111 to produce the sound of the target note at the correct pitch at the timing the performance action is detected. If a performance action is not detected within the early press period or the period A, the CPU 101 causes the sound production unit 111 to produce the sound of the target note at the correct pitch at the delayed sound production timing. If a performance action is detected within the period B, the CPU 101 performs control not to produce the sound of a first performance action that is firstly made within the period B. Thereafter, if a second performance action is detected within the period B, the CPU 101 causes the sound production unit 111 to produce the sound at a pitch corresponding to the second performance action and at the timing the second performance action is detected. If a sound is produced at a delayed sound production timing and no performance action is detected until the next delayed sound production timing, the CPU 101 performs control not to produce a sound at the next delayed sound production timing.

In summary, in the performance support function, if a performance action is detected within the early press period, the sound is produced at the sound production timing; if a performance action is detected within the period A, the sound is produced at the timing the performance action is detected; and if no performance action is detected within the period A, the sound is produced at the delayed sound production timing. If a sound is produced at a delayed sound production timing and no performance action by the user is detected until the next delayed sound production timing of the next target note, the sound of the next target note is not produced at the next delayed sound production timing. That is, if the user stops the performance, sounds are not produced.

The length of the early press period and the period A may be determined as desired. It is preferable that the length of the early press period and the period A be determined by the CPU 101 depending on the lengths of notes of the musical piece. For example, for a musical piece mainly constituted of eighth notes, the early press period is set to half the length of an eighth note, namely the length of a sixteenth note; and the period A is set to half the length of a sixteenth note, namely the length of a thirty-second note. In this case, the sound of a performance action earlier than the sound production timing is produced at the sound production timing; and the sound of a delayed performance action is produced within the length of a thirty-second note from the sound production timing. The delay by the length of a thirty-second note can be considered a correct performance. Thus, the period A is set to a length that can be considered a correct sound production timing.

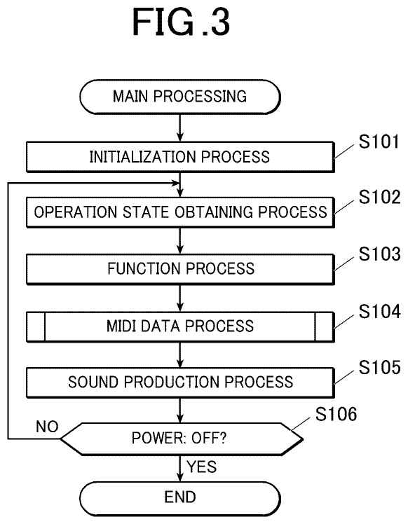

FIG. 3 is a flowchart of main processing that is executed after the information processing apparatus 1 is turned on. The main processing is executed by the CPU 101 in cooperation with the program stored in the ROM 102 or the storage 104.

In the main processing, the CPU 101 firstly executes initialization process (Step S101). In the initialization process, the CPU 101 executes initialization of the components constituting the information processing apparatus 1 and initialization of variables to be used in various processes (e.g., turning on a sound-production-reserved flag, a and sound-production-done flag, a performance-in-progress flag, which are described later).

Next, the CPU 101 executes an operation state obtaining process (Step S102).

In the operation state obtaining process, the CPU 101 obtains the operation state of the switches of the operation receiver 106.

Next, the CPU 101 executes a function process (Step S103).

In the function process, the CPU 101 executes functions corresponding to the operation state of the switches, based on the operation state of the switches of the operation receiver 106, which is obtained in the operation state obtaining process. For example, when a switch for selecting a musical piece is pressed, the CPU 101 loads the music data of the musical piece selected by the press of the switch from the storage 104 to the RAM 103. For another example, when a switch for turning on the performance support function is pressed, the CPU 101 turns on the performance support function. When a musical piece is selected and a switch for starting the performance is pressed with the performance support function turned on, the CPU 101 starts progressing the selected musical piece. For example, the CPU 101 starts playing a part of the music (herein, the accompaniment part) other than the part to be played by the user (herein, the melody part), based on the music data loaded in the RAM 103.

When neither of the switches are operated, the CPU 101 proceeds to Step S104.

The CPU 101 executes a MIDI data process (Step S104).

In the MIDI data process, the CPU 101 executes processing related to MIDI data input from the electronic musical instrument 2 via the MIDI interface 107. Details are described later. When MIDI data is not input from the electronic musical instrument 2, the CPU 101 proceeds to Step S105.

The CPU 101 executes a sound production process (Step S105).

In the sound production process, the CPU 101 drives the sound source 108 and causes the sound production unit 111 to produce sounds or silencing sounds, based on sound production instruction information or sound silencing instruction information output to the sound source 108 in the MIDI data process and so forth.

When there is no sound to be produced or silenced, the CPU 101 proceeds to Step S106.

The CPU 101 determines whether the power supply switch of the operation receiver 106 is pressed or not (Step S106).

When determining that the power supply switch of the operation receiver 106 is not pressed (step S106: NO), the CPU 101 returns to step S102.

When determining that the power supply switch of the operation receiver 106 is pressed (step S106: YES), the CPU 101 ends the main processing.

Hereinafter, the MIDI data process executed in Step S104 of FIG. 3 is described.

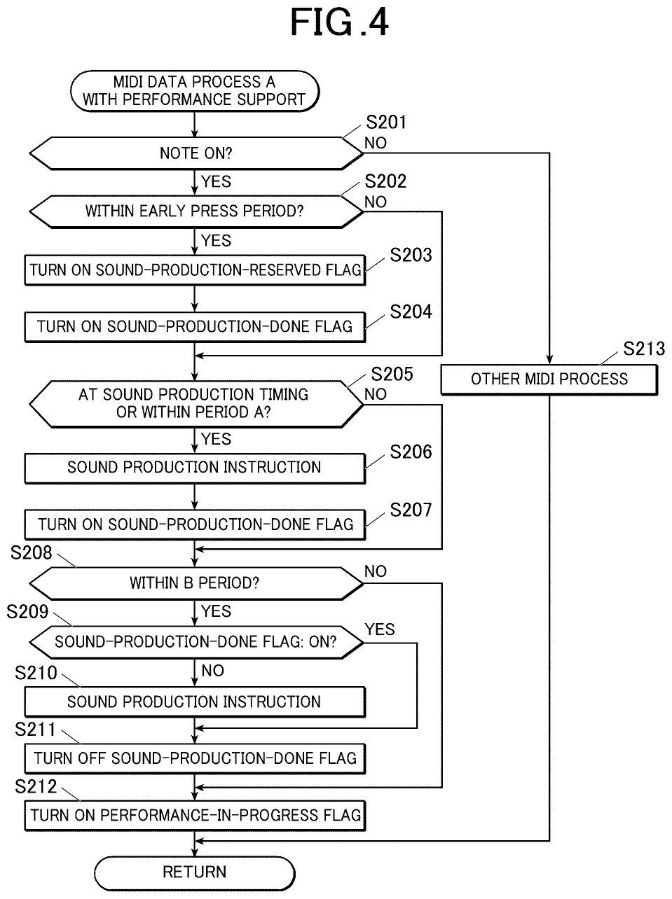

When the performance support function is not on, in the MIDI data process, the CPU 101 outputs sound production instruction information, sound silencing instruction information, and so forth to the sound source 108, based on MIDI data input by the electronic musical instrument 2, for example. When the performance support function is on, the CPU 101 executes the MIDI data process with the performance support, which is shown in FIG. 4.

FIG. 4 is a flowchart of the MIDI data process with the performance support in this embodiment. The MIDI data process with the performance support is executed by the CPU 101 in cooperation with the program stored in the ROM 102 or the storage 104. The MIDI data process with the performance support in this embodiment is referred to as the MIDI data process A to be distinguishable from the MIDI data process with the performance support in the second embodiment.

In the MIDI data process A with the performance support, the CPU 101 firstly determines whether the input MIDI data is a note-on event or not (Step S201).

When determining that the input MIDI data is a note-on event (Step S201: YES), the CPU 101 determines whether the current point of the musical piece in progress is within the early press period or not (Step S202).

When determining that the current point of the musical piece in progress is within the early press period (Step S202: YES), namely determining that a note-on event is input within the early press period (a performance action is detected within the early press period), the CPU 101 turns on the sound-production-reserved flag (Step S203).

The sound-production-reserved flag indicates whether the sound production is reserved or not at the next sound production timing. The sound-production-reserved flag is turned on if the sound production is reserved at the next sound production timing.

The CPU 101 turns on the sound-production-done flag (Step S204) and proceeds to Step S205.

The sound-production-done flag is a flag for determining whether or not to produce a sound at the delayed sound production timing or within the period B. For example, the sound-production-done flag is turned on when (i) the sound production is reserved within the early press period, (ii) when a sound is produced within the period A, or (iii) when a sound is produced at the delayed sound production timing, for example.

When determining that the current point of the musical piece in progress is not within the early press period (Step S202: NO), the CPU 101 proceeds to Step S205.

In Step S205, the CPU 101 determines whether or not the current point of the musical piece in progress is at the sound production timing or within the period A (delayed sound production stand-by period) (Step S205).

When determining that the current point of the musical piece in progress is not at the sound production timing or within the period A (Step S205: NO), the CPU 101 proceeds to Step S208.

When determining that the current point of the musical piece in progress is at the sound production timing or within the period A (Step S205: YES), namely determining that the note-on event is input at the sound production timing or within the period A (a performance action is detected at the sound production timing or within the period A), the CPU 101 outputs, to the sound source 108 of the sound production unit 111, sound production instruction information to produce a sound at a correct pitch that should be produced at the point of time, regardless of the note number (pitch) specified by the note-on event (Step S206). The CPU 101 turns on the sound-production-done flag (Step S207) and proceeds to Step S208.

If the current point of time is the sound production timing, the correct pitch that should be produced at the point of time is the pitch that should be produced at the timing in the musical piece in progress. If the current point of time is within the period A, the correct pitch that should be produced at the point of time is the pitch that should have been produced at the sound production timing immediately before the current point of time. In the sound production process in Step S105 of FIG. 3, the sound production unit 111 produces a sound in accordance with the sound production instruction information.

That is, the sound is produced at a correct timing and at a correct pitch as specified in the musical piece, regardless of the pitch of the user's performance action. The sound produced in the period A is slightly delayed from the sound production timing specified in the musical piece but can be regarded as the correct timing.

In Step S208, the CPU 101 determines whether the current point of the musical piece in progress is within the period B (Step S208).

When determining that the current point of the musical piece in progress is not within the period B (Step S208: NO), the CPU 101 proceeds to Step S212.

When determining that the current point of the musical piece in progress is within the period B (Step S208: YES), the CPU 101 determines whether the sound-production-done flag is on or not (Step S209).

When determining that the sound-production-done flag is not on (Step S209: NO), the CPU 101 outputs, to the sound source 108, sound production instruction information to produce a sound at a pitch corresponding to the note number specified in the note-on event (Step S210). The CPU 101 then proceeds to Step S211.

In the sound production process in step S105 of FIG. 3, the sound production unit 111, which includes the sound source 108, produces a sound in accordance with the sound production instruction information.

When determining that the sound-production-done flag is on (Step S209: YES), the CPU 101 proceeds to Step S211.

Here, if the sound of a note that should be produced in the musical piece is produced within the early press period or the period A or at the delayed sound production timing in the tick process (described later), the sound-production-done flag is on in step S209. Therefore, in step S210, the sound production instruction is not made for the note-on event (performance action). The sound-production-done flag is then turned off in the next step S211. Therefore, next time a note-on event is input in the period B, the sound production instruction is made for the note-on event.

That is, after the sound of a note is produced within the early press period or the period A or at the delayed sound production timing in the tick process (described later), the sound production corresponding to a performance action detected within the subsequent period B is cancelled by only one time (i.e., the sound production unit 111 does not produce a sound). A first performance action that is firstly made within the period B is considered a delayed performance action caused by an immature performance of the user. Since the sound of the note has already been produced at a correct pitch at a correct timing, the sound need not be produced again. However, a second performance action after the one time cancellation of the sound production is considered an intentional performance action by the user as a musical expression, and the sound need be produced for the second performance action. Therefore, in the period B, only the sound production corresponding to the first note-on event is cancelled.

In Step S211, the CPU 101 turns off the sound-production-done flag (Step S211) and proceeds to Step S212.

In Step S212, the CPU 101 turns on the performance-in-progress flag (Step S212) and proceeds to Step S105 in FIG. 3.

The performance-in-progress flag is for the CPU 101 to determine whether the user keeps making the performance actions or not. The performance-in-progress flag is turned on when a note-on event is input, namely when a performance action on the electronic musical instrument 2 is detected.

On the other hand, when determining that the input MIDI data is not a note-on event (Step S201: NO), the CPU 101 executes processing based on the input MIDI data (Step S213) and proceeds to Step S105 in FIG. 3.

For example, when the input MIDI data is a note-off event, the CPU 101 outputs, to the sound source 108 of the sound production unit 111, sound silencing instruction information for the sound at the pitch specified in the note-off event. For another example, when the input MIDI data is information on a control change or a program change, the CPU 101 changes settings on the sound volume, the timbre, and so forth, based on the input MIDI data.

The information processing apparatus 1 executes the tick process at predetermined time intervals. The tick process is activated at predetermined time intervals by timer interrupts while the information processing apparatus 1 is turned on. In this embodiment, the interval of the timer interrupts is one millisecond, for example.

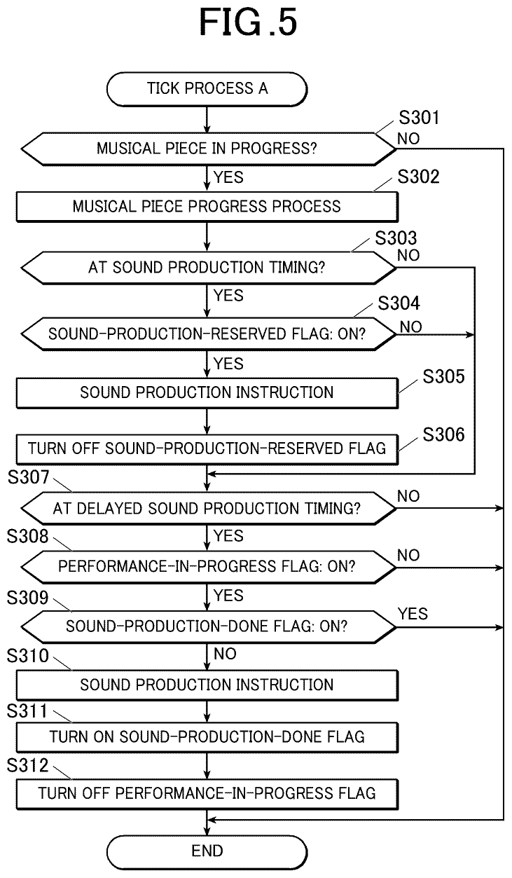

FIG. 5 is a flowchart of the tick process. The tick process is executed by the CPU 101 in cooperation with the program stored in the ROM 102 or the storage 104. The tick process in this embodiment is referred to as the tick process A to be distinguishable from the tick process in the second embodiment.

In the tick process A, the CPU 101 determines whether a musical piece is in progress or not (Step S301).

For example, the CPU 101 determines that a musical piece is not in progress if the musical piece is stopped or if a musical piece to be played is not selected.

When determining that a musical piece is not in progress (Step S301: NO), the CPU 101 ends the tick process.

When determining that a musical piece is in progress (Step S301: YES), the CPU 101 executes a musical piece progress process (Step S302).

In the musical piece progress process, the CPU 101 progresses the musical piece by the amount of time corresponding to the time difference between the last tick process and the current tick process (by the amount of time having elapsed since the last tick process), for example. In this embodiment, the CPU 101 causes the sound production unit 111 to produce sounds of the accompaniment that should be produced in the elapsed time, or the CPU 101 processes events that should be executed in the elapsed time, such as a program change or a control change, for example.

Next, the CPU 101 determines whether the current point of the musical piece in progress is at the sound production timing of the melody or not (Step S303).

When determining that the current point of the musical piece in progress is at the sound production timing (Step S303: YES), the CPU 101 determines whether the sound-production-reserved flag is on or not (Step S304).

Herein, the sound-production-reserved flag is on if a note-on event has been input (a performance action has been detected) in the early press period.

When determining that the sound-production-reserved flag is on (Step S304: YES), the CPU 101 outputs, to the sound source 108, sound production instruction information to produce a sound at a correct pitch that should be produced at the current timing in the musical piece (Step S305).

In accordance with the sound production instruction information, the sound production unit 111 produces a sound in the sound production process in Step S105 of FIG. 3.

That is, in response to a note-on event (performance action) in the early press period, the sound production unit 111 produces the sound of the note at the correct pitch at the perfect timing (sound production timing) at which the sound of the note should be produced in the musical piece.

Next, the CPU 101 turns off the sound-production-reserved flag (Step S306) and proceeds to S307.

In Step S303, when determining that the current point of the musical piece in progress is not at the sound production timing of the melody (Step S303: NO), or in Step S304, when determining that the sound-production reserved flag is not on (Step S304: NO), the CPU 101 proceeds to Step S307.

In Step S307, the CPU 101 determines whether the current point of the musical piece in progress is at the delayed sound production timing or not (Step S307).

When determining that the current point of the musical piece in progress is at the delayed sound production timing (Step S307: YES), the CPU 101 determines whether the performance-in-progress flag is on or not (Step S308).

That is, the CPU 101 determines whether the user keeps making performance actions or not.

When determining that the performance-in-progress flag is on (Step S308: YES), the CPU 101 determines whether the sound-production-done flag is on or not (Step S309).

When determining that the sound-production-done flag is not on (Step S309: NO), the CPU 101 outputs, to the sound source 108, sound production instruction information to produce a sound at the pitch that should have been produced at the sound production timing immediately before the current point in the musical piece (Step S310).

In accordance with the sound production instruction information, the sound production unit 111 produces a sound in the sound production process in Step S105 of FIG. 3.

That is, even if the user is unable to make a performance action by the delayed sound production timing, a sound is produced at the correct pitch specified in the musical piece at the delayed sound production timing, which is regarded as the correct sound production timing.

Next, the CPU 101 turns on the sound-production-done flag (Step S311), turns off the performance-in-progress flag (Step S312), and ends the tick process.

Herein, producing a sound at the delayed sound production timing (the sound production instruction information is output in Step S310) means that a performance action by the user has not been detected from the early press period to the delayed sound production timing. In Step S312, the CPU 101 turns off the performance-in-progress flag and performs control not to produce sounds at subsequent delayed sound production timings until a performance action is detected. That is, if the user thereafter does not make a performance action, sounds of notes at correct pitches are not automatically produced at subsequent delayed sound production timings. On the other hand, if the user makes any performance action, the performance-in-progress flag is turned on (Step S212 in FIG. 4), and the CPU 101 continues the delayed sound production support. Thus, the CPU 101 avoids the situation in which sounds of notes are produced even though the user is not playing.

On the other hand, when determining that the current point of the musical piece in progress is not at the delayed sound production timing (Step S307: NO); when determining that the performance-in-progress flag is not on (Step S308: NO): or when the sound-production-done flag is on (Step S309: YES), the CPU 101 ends the tick process.

Thus, in the first embodiment, timings for producing sounds corresponding to performance actions can be appropriately corrected, based on sound production timings specified in a musical piece. Thus, even a user with immature techniques can play a musical piece at correct timings. The sounds of notes are not produced when the user stops playing the musical piece. Thus, the information processing apparatus 1 avoids producing sounds when the user is not playing the musical piece and thereby avoids interrupting the user feeling that he/she is playing the musical piece on his/her own.

### Second Embodiment

Next, a second embodiment of the present invention is described.

The configuration of the information processing apparatus 1 in the second embodiment is the same as the one described in the first embodiment, and the description thereof is omitted. Hereinafter, the operation in the second embodiment is described.

In the second embodiment, the information processing apparatus 1 executes the main processing of FIG. 3 described in the first embodiment. The MIDI data process with the performance support, which is executed in Step S104 when the performance support function is on, and the tick process in the second embodiment are different from those in the first embodiment. Hereinafter, the MIDI data process with the performance support and the tick process in the second embodiment are described. The MIDI data process with the performance support in the second embodiment is referred to as the MIDI data process B to be distinguishable from the MIDI data process with the performance support in the first embodiment. Also, the tick process in the second embodiment is referred to as the tick process B.

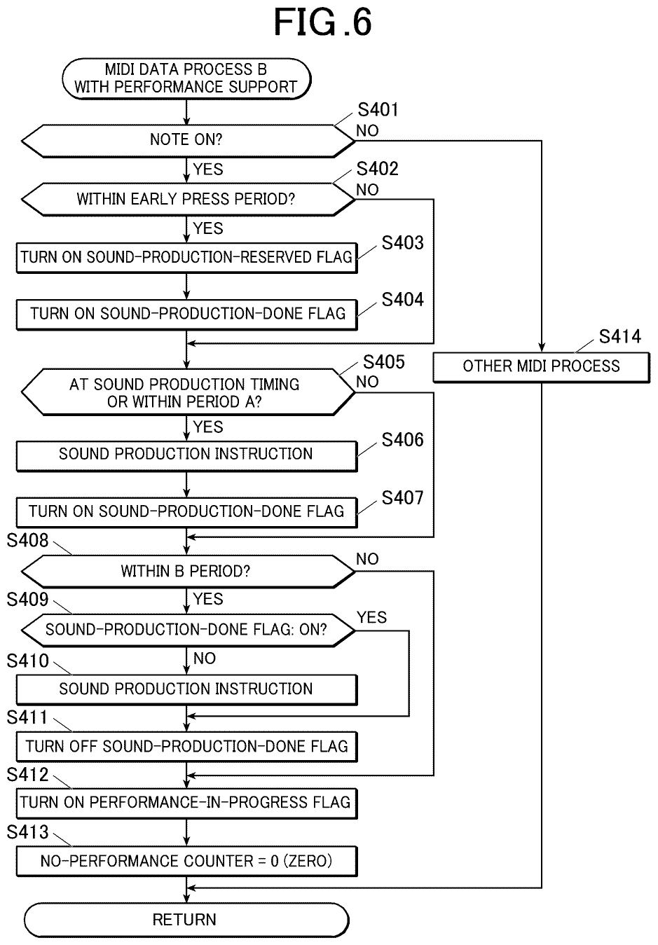

FIG. 6 is a flowchart of the MIDI data process B with the performance support in the second embodiment. This process is executed by the CPU 101 in cooperation with the program stored in the ROM 102 or the storage 104.

In the MIDI data process B with the performance support, the CPU 101 firstly determines whether the input MIDI data is a note-on event or not (Step S401).

When determining that the input MIDI data is a note-on event (Step S401: YES), the CPU 101 determines whether the current point of the musical piece in progress is within the early press period or not (Step S402).

When determining that the current point of the musical piece in progress is within the early press period (Step S402: YES), the CPU 101 executes the process of Steps S403 and S404 and proceeds to Step S405. Since the process of steps S403 and S404 is the same as the process of steps S203 and S204 in FIG. 4, the description thereof is omitted.

When determining that the current point of the musical piece in progress is not within the early press period (Step S402: NO), the CPU 101 proceeds to Step S405.

In Step S405, the CPU 101 determines whether or not the current point of the musical piece in progress is at the sound production timing or within the period A (delayed sound production stand-by period) (Step S405).

When determining that the current point of the musical piece in progress is not at the sound production timing or within the period A (Step S405: NO), the CPU 101 proceeds to Step S408.

On the other hand, when determining that the current point of the musical piece in progress is at the sound production timing or within the period A (Step S405: YES), the CPU 101 executes the process of Steps S406 and S407 and proceeds to Step S408. Since the process of steps S406 and S407 is the same as the process of steps S206 and S207 in FIG. 4, the description thereof is omitted.

In Step S408, the CPU 101 determines whether the current point of the musical piece in progress is within the period B (Step S408).

When determining that the current point of the musical piece in progress is not within the period B (Step S408: NO), the CPU 101 proceeds to Step S412.

When determining that the current point of the musical piece in progress is within the period B (Step S408: YES), the CPU 101 determines whether the sound-production-done flag is on or not (Step S409).

When determining that the sound-production-done flag is on (Step S409: YES), the CPU 101 proceeds to Step S411.

When determining that the sound-production-done flag is not on (Step S409: NO), the CPU 101 performs the process of Step S410 (Step S410) and proceeds to Step S411. Since the process of step S410 is the same as the process of step S210 in FIG. 4, the description thereof is omitted.

In Step S411, the CPU 101 turns off the sound-production-done flag (Step S411) and proceeds to Step S412.

In Step S412, the CPU 101 turns on the performance-in-progress flag (Step S412).

Next, the CPU 101 sets a no-performance counter to zero (0) (Step S413) and proceeds to Step S105 in FIG. 3.

The no-performance counter counts notes for which a performance action is not detected and the sound of which is produced at the delayed sound production timing. When a note-on event is input, the no-performance counter is reset to zero.

When determining that the input MIDI data is not a note-on event (Step S401: NO), the CPU 101 executes processing based on the input MIDI data (Step S414) and proceeds to Step S105 in FIG. 3.

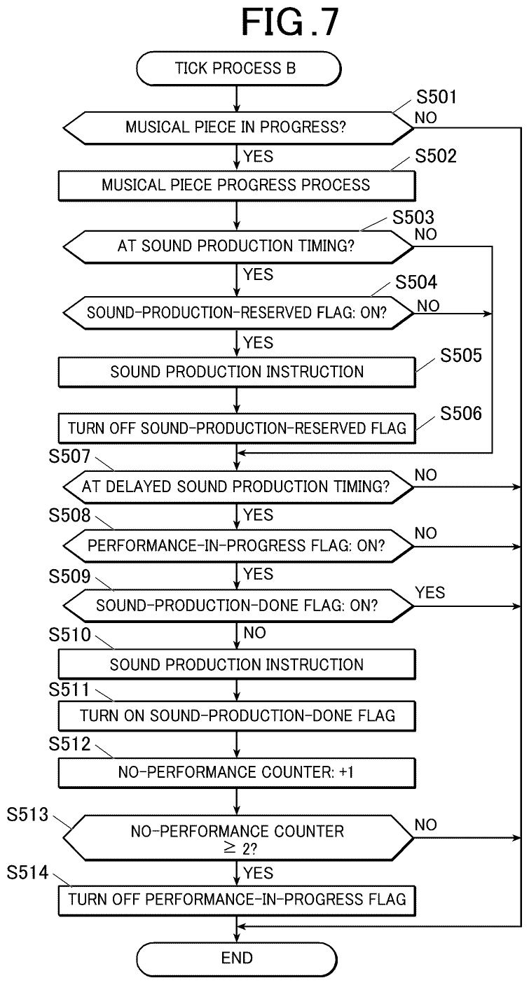

FIG. 7 is a flowchart of the tick process in the second embodiment. The tick process B is executed by the CPU 101 in cooperation with the program stored in the ROM 102 or the storage 104.

In the tick process B, the CPU 101 firstly determines whether a musical piece is in progress (Step S501).

When determining that a musical piece is not in progress (Step S501: NO), the CPU 101 ends the tick process B.

When determining that a musical piece is in progress (Step S501: YES), the CPU 101 executes a musical piece progress process (Step S502).

Next, the CPU 101 determines whether the current point of the musical piece in progress is at a sound production timing of the melody or not (Step S503).

When determining that the current point of the musical piece in progress is at a sound production timing of the melody (Step S503: YES), the CPU 101 determines whether the sound-production-reserved flag is on or not (Step S504).

When determining that the sound-production-reserved flag is on (Step S504: YES), the CPU 101 executes the process of Steps S505 and S506 and proceeds to Step S507. Since the process of steps S505 and S506 is the same as the process of steps S305 and S306 in FIG. 5, the description thereof is omitted.

In Step S503, when determining that the current point of the musical piece in progress is not at a sound production timing of the melody (Step S503: NO), or in Step S504, when determining that the sound-production reserved flag is not on (Step S504: NO), the CPU 101 proceeds to Step S507.

In Step S507, the CPU 101 determines whether the current point of the musical piece in progress is at a delayed sound production timing or not (Step S507).

When determining that the current point of the musical piece in progress is at a delayed sound production timing (Step S507: YES), the CPU 101 determines whether the performance-in-progress flag is on or not (Step S508).

When determining that the performance-in-progress flag is on (Step S508: YES), the CPU 101 determines whether the sound-production-done flag is on or not (Step S509).

When determining that the sound-production-done flag is not on (Step S509: NO), the CPU 101 outputs, to the sound source 108, sound production instruction information to produce a sound at the pitch that should have been produced at the sound production timing immediately before the current point in the musical piece (Step S510).

Next, the CPU 101 turns on the sound-production-done flag (Step S511) and increments the no-performance counter (Step S512).

The CPU 101 determines whether or not the no-performance counter is equal to or greater than two (step S513).

When determining that the no-performance counter is not equal to or greater than two (step S513: NO), the CPU 101 ends the tick process B.

When determining that the no-performance counter is equal to or greater than two (Step S513: YES), the CPU 101 turns off the performance-in-progress flag (step S514) and ends the tick process B.

Herein, the performance-in-progress flag is turned off if the no-performance counter is equal to or greater than two. That is, the performance-in-progress flag is turned off if sounds of consecutive two notes, a first note and a second note, are automatically produced at their respective delayed sound production timings and no performance action is detected from the early press period of the first note until the delayed sound production timing of the second note. That is, after the sound of the second note is produced at the delayed sound production timing, sounds are not produced at delayed sound production timings until a performance action is detected. In other words, sounds of two notes are produced at their respective delayed sound production timings even if a performance action is not detected. When a performance action is detected, the performance-in-progress flag is turned on in Step S412 in FIG. 6, and the no-performance counter is reset. That is, even if the user cannot timely make performance actions for a rapid phrase, sounds corresponding to absent performance actions are automatically produced as long as the user keeps playing.

In the second embodiment, in a situation that the user's performance actions are not detected for consecutive two notes, the information processing apparatus 1 does not produce sounds of notes at delayed sound production timings after the consecutive two notes. However, the information processing apparatus 1 may be configured not to produce sounds of notes at delayed sound production timings after the user's performance actions are not detected for consecutive three notes or more. However, it is not preferable to increase the number of automatically produced notes to three, four, or greater because the greater the number of automatically produced sounds are, the less the user feels that he/she is playing the musical piece on his/her own.

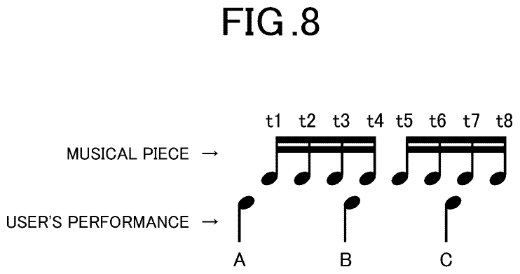

FIG. 8 is a schematic drawing for explaining the performance support operation in the second embodiment.

In FIG. 8, sixteenth notes t1 to t8 in the upper row indicate original sound production timings at which the sounds of notes should be produced according to a musical piece. In FIG. 8, quarter notes A to C in the lower row indicate user's performance actions.

The user's performance action A is earlier than the timing t1, which is an original sound production timing. Therefore, the user's performance A is within the early press period. With the sound-production-reserved flag, the sound corresponding to the performance action A is produced at the timing t1. The sounds of notes at the sound production timings t2 and t3 are automatically produced by the performance support function. Since the user does not make performance actions for the consecutive two notes, the performance-in-progress flag is turned off once. Then, by the user's performance action B, the performance-in-progress flag is again turned on; the sound of t4 is produced by the sound production reservation corresponding to the performance action B; and the sounds of t5 and t6, for which performance actions are not made, are automatically produced at their respective delayed sound production timings. Since the user does not make performance actions for the consecutive two notes, the performance-in-progress flag is turned off once. Then, by the user's performance action C, the performance-in-progress flag is again turned on; the sound of t7 is produced by the sound production reservation corresponding to the performance action C; and the sound of t8, for which a performance action is not made, is automatically produced at the delayed sound production timing.

Thus, by the support of the performance support function of the second embodiment, the user can play a musical piece including sixteenth notes even if the user can make performance actions for quarter notes only. Since sounds are not produced when the user stops performance actions, the user can feel that he/she is playing the musical piece on his/her own.

As described above, in a situation that a performance action is detected within the early press period, which is between an early time point being earlier than a sound production timing by a predetermined time and the sound production timing being a timing of producing a sound of a note specified in a musical piece, the CPU 101 of the information processing apparatus 1 causes the sound production unit 111 to produce a sound corresponding to the performance action at the sound production timing. In a situation that no performance action is detected within the early press period or at the sound production timing, the CPU 101 does not cause the sound production unit 111 to produce a sound at the sound production timing.

Thus, the CPU 101 can appropriately correct timings for producing sounds corresponding to performance actions, based on sound production timings specified in the musical piece. More specifically, when a performance action is detected within the early press period, the sound corresponding to the performance action is produced at the sound production timing specified in the musical piece.

Further, in a situation that a performance action is detected between the sound production timing specified in the musical piece and the delayed sound production timing, which is a timing later than the sound production timing by a predetermined time, the CPU 101 causes the sound production unit 111 to produce a sound at a timing the performance action is detected.

Thus, if a performance action is not detected until the sound production timing but is detected until the delayed sound production timing, which is considered a correct sound production timing, the CPU 101 causes the sound production unit 111 to produce a sound at a timing the performance action is detected.

Further, in a situation that no performance action is detected from the early press period to the delayed sound production timing, the CPU 101 causes the sound production unit 111 to produce a sound at the delayed sound production timing.

Thus, if a performance action is not detected until the delayed sound production timing, the CPU 101 causes the sound production unit 111 to produce a sound at the delayed sound production timing, which is considered a correct sound production timing.

Further, in the situation that no performance action is detected from the early press period to the delayed sound production timing, after causing the sound production unit 111 to produce a sound at the delayed sound production timing, the CPU 101 does not cause the sound production unit 111 to produce a sound at a delayed sound production timing corresponding to a sound production timing of a subsequent note specified in the musical piece until a performance action is detected.

Thus, sounds are not automatically produced when the user stops the performance. The CPU 101 avoids producing sounds when the user no longer plays the musical piece and thereby avoids interrupting the user feeling that he/she is playing the musical piece on his/her own.

Further, in a situation that the CPU 101 causes the sound production unit 111 to produce sounds of two consecutive notes including a first note and a second note in the musical piece at a first delayed sound production timing and a second delayed sound production timing, respectively and that no performance action is detected from an early press period of the first note to the second delayed sound production timing of the second note, after causing the sound production unit 111 to produce a sound at the second delayed sound production timing of the second note, the CPU 101 does not cause the sound production unit 111 to produce a sound at a delayed sound production timing corresponding to a sound production timing of a subsequent note that comes after the second note in the musical piece until a performance action is detected.

Thus, even if performance actions are not detected, sounds of two notes are automatically produced at their respective delayed sound production timings. Even if the user cannot timely make performance actions for a rapid phrase, sounds corresponding to absent performance actions are automatically produced at delayed sound production timings as long as the user keeps playing.

Further, in a situation that the CPU 101 causes the sound production unit 111 to produce a sound of the target note that should be produced at the sound production timing until the delayed sound production timing and that a first performance action is detected within a period between the delayed sound production timing of the target note and a beginning of an early press period corresponding to a next sound production timing, the CPU 101 does not cause the sound production unit 111 to produce a sound corresponding to the first performance action, which is firstly detected within the period.

Thus, the CPU 101 avoids producing a sound of a note that has already been produced at its correct timing when the user's performance action is delayed.

Further, the CPU 101 causes the sound production unit 111 to produce a sound at a correct pitch, the correct pitch being a pitch that should be produced at the sound production timing specified in the musical piece. Thus, sounds are produced at correct pitches.

The first and second embodiments described above are preferable examples of the information processing apparatus, the electronic musical instrument, the sound production control method, and the program of the present invention, and are not intended to limit the present invention.

For example, in the above embodiments, sounds of notes are produced at correct pitches regardless of the pitches of keys on which performance actions are made. However, sounds of notes may be produced at pitches of keys on which performance actions are made, and the information processing apparatus 1 may be configured to correct sound production timings only. Further, sounds may be produced at a constant velocity or may be produced at velocities specified in music data or at velocities corresponding to the user's performance actions.

Further, in the above embodiments, the information processing apparatus 1 is separate from the electronic musical instrument 2 as an example. However, the electronic musical instrument 2 may be provided with the function of the CPU 101 of the information processing apparatus 1 in the present invention and/or the sound production unit, for example.

Further, in the above embodiments, the electronic musical instrument 2 is a keyboard as an example. However, the electronic musical instrument 2 may be any other electronic musical instrument, such as a wind synthesizer, an electric guitar, or a MIDI violin.

Further, in the above embodiments, the present invention is applied to the performance support for the melody of a musical piece. However, the present invention may be applied to the performance support for other parts of a musical piece, such as the accompaniment, for example.

Further, in the above embodiments, a semiconductor memory such as a ROM and a hard disk are disclosed as examples of a computer-readable medium storing the program of the present invention. However, the computer readable medium is not limited to these examples. As the computer readable medium, a portable storage medium, such as a CD-ROM, can also be used. In addition, a carrier wave is also applied as a medium for providing data of the program according to the present invention via a communication line.

The detailed configuration and the detailed operation of the information processing apparatus 1 can be suitably modified without departing from the scope of the present invention.

Although the embodiments of the present invention have been described above, the technical scope of the invention is not limited to the embodiments described above. The technical scope of the invention is defined based on the scope of the claims. Furthermore, the technical scope of the present invention includes equivalents in which modifications that are not related to the essence of the invention are added to the scope of the claims.

1. An information processing apparatus comprising:
a storage that stores a program; and
a processor configured to perform control in accordance with the program stored in the storage, wherein
a sound production timing is a timing of producing a sound of a target note, the sound production timing being specified in a musical piece;
an early press period is between an early time point and the sound production timing, the early time point being earlier than the sound production timing by a predetermined time;
in a situation that a performance action is detected within the early press period, the processor causes a sound production unit to produce a sound corresponding to the performance action at the sound production timing; and
in a situation that no performance action is detected within the early press period or at the sound production timing, the processor does not cause the sound production unit to produce a sound at the sound production timing.

2. The information processing apparatus according to claim 1, wherein
a delayed sound production timing is a timing later than the sound production timing by a predetermined time; and
in a situation that a performance action is detected between the sound production timing and the delayed sound production timing, the processor causes the sound production unit to produce a sound at a timing the performance action is detected.

3. The information processing apparatus according to claim 2, wherein
in a situation that no performance action is detected from the early press period to the delayed sound production timing, the processor causes the sound production unit to produce a sound at the delayed sound production timing.

4. The information processing apparatus according to claim 3, wherein
in the situation that no performance action is detected from the early press period to the delayed sound production timing, after causing the sound production unit to produce a sound at the delayed sound production timing, the processor does not cause the sound production unit to produce a sound at a delayed sound production timing corresponding to a sound production timing of a subsequent note that comes after the target note in the musical piece until a performance action is detected.

5. The information processing apparatus according to claim 3, wherein
in a situation that the processor causes the sound production unit to produce sounds of two consecutive notes including a first note and a second note in the musical piece at a first delayed sound production timing and a second delayed sound production timing, respectively and that no performance action is detected from an early press period of the first note to the second delayed sound production timing of the second note, after causing the sound production unit to produce a sound at the second delayed sound production timing of the second note, the processor does not cause the sound production unit to produce a sound at a delayed sound production timing corresponding to a sound production timing of a subsequent note that comes after the second note in the musical piece until a performance action is detected.

6. The information processing apparatus according to claim 2, wherein
in a situation that the processor causes the sound production unit to produce a sound of the target note that should be produced at the sound production timing until the delayed sound production timing and that a first performance action is detected within a period between the delayed sound production timing of the target note and a beginning of an early press period corresponding to a next sound production timing, the processor does not cause the sound production unit to produce a sound corresponding to the first performance action, which is firstly detected within the period.

7. The information processing apparatus according to claim 6, wherein
the processor causes the sound production unit to produce a sound corresponding to a second performance action that is detected after the first performance action.

8. An electrical musical instrument comprising:
the information processing apparatus according to claim 1; and
a performance action receiver configured to receive a performance action by a user.

9. A sound production method for a computer, wherein
a sound production timing is a timing of producing a sound of a target note, the sound production timing being specified in a musical piece;
an early press period is between an early time point and the sound production timing, the early time point being earlier than the sound production timing by a predetermined time;
in a situation that a performance action is detected within the early press period, the computer causes a sound production unit to produce a sound corresponding to the performance action at the sound production timing; and
in a situation that no performance action is detected within the early press period or at the sound production timing, the computer does not cause the sound production unit to produce a sound at the sound production timing.

10. The method according to claim 9, wherein
a delayed sound production timing is a timing later than the sound production timing by a predetermined time; and
in a situation that a performance action is detected between the sound production timing and the delayed sound production timing, the computer causes the sound production unit to produce a sound at a timing the performance action is detected.

11. The method according to claim 10, wherein
in a situation that no performance action is detected from the early press period to the delayed sound production timing, the computer causes the sound production unit to produce a sound at the delayed sound production timing.

12. The method according to claim 11, wherein
in the situation that no performance action is detected from the early press period to the delayed sound production timing, after causing the sound production unit to produce a sound at the delayed sound production timing, the computer does not cause the sound production unit to produce a sound at a delayed sound production timing corresponding to a sound production timing of a subsequent note that comes after the target note in the musical piece until a performance action is detected.

13. The method according to claim 11, wherein
in a situation that the computer causes the sound production unit to produce sounds of two consecutive notes including a first note and a second note in the musical piece at a first delayed sound production timing and a second delayed sound production timing, respectively and that no performance action is detected from an early press period of the first note to the second delayed sound production timing of the second note, after causing the sound production unit to produce a sound at the second delayed sound production timing of the second note, the computer does not cause the sound production unit to produce a sound at a delayed sound production timing corresponding to a sound production timing of a subsequent note that comes after the second note in the musical piece until a performance action is detected.

14. The method according to claim 10, wherein
in a situation that the computer causes the sound production unit to produce a sound of the target note that should be produced at the sound production timing until the delayed sound production timing and that a first performance action is detected within a period between the delayed sound production timing of the target note and a beginning of an early press period corresponding to a next sound production timing, the computer does not cause the sound production unit to produce a sound corresponding to the first performance action, which is firstly detected within the period.

15. A computer-readable storage medium storing a program for a computer, wherein
a sound production timing is a timing of producing a sound of a target note, the sound production timing being specified in a musical piece;
an early press period is between an early time point and the sound production timing, the early time point being earlier than the sound production timing by a predetermined time;
in a situation that a performance action is detected within the early press period, the computer causes a sound production unit to produce a sound corresponding to the performance action at the sound production timing; and
in a situation that no performance action is detected within the early press period or at the sound production timing, the computer does not cause the sound production unit to produce a sound at the sound production timing.
